(19) United States
(12) Patent Application Publication
(10) Pub. No.: US 2016/0221492 A1
(43) Pub. Date: Aug. 4, 2016

(54) METHOD AND SYSTEM FOR CONTROLLING FUNCTIONS IN A VEHICLE

(71) Applicant: WABCO GMBH, Hannover (DE)

(72) Inventors: Axel Stender, Hameln (DE); Norbert Witte, Lauenau (DE)

(21) Appl. No.: 15/022,100

(22) PCT Filed: Jul. 11, 2014
(86) PCT No.: PCT/EP2014/001913

§ 371 Date: Mar. 15, 2016

(30) Foreign Application Priority Data
Sep. 19, 2013 (DE) 10 2013 015 590.8

(51) Int. Cl. B60Q 1/22; B60T 8/17; B62D 61/12; B60Q 5/00

(52) U.S. Cl. CPC B60Q 1/22; B60Q 5/005; B60T 8/1708; B62D 61/12; B60T 2250/00; B60T 2230/08

(57) ABSTRACT

A method controls functions in a vehicle having at least one wheel-speed sensor (15) and having one or more signal generators and/or signal receivers assigned, in particular, to a vehicle rear. In accordance with the method, a direction of rotation is also detected with the wheel-speed sensor (15). In addition, the signal generators and/or signal receivers are actuated automatically in a manner depending on signals of the wheel-speed sensor (15).

### TECHNICAL FIELD

The invention relates to a method for controlling functions in a vehicle having at least one wheel-speed sensor. Said vehicle may exhibit one or more signal generators and/or signal receivers assigned, in particular, to a vehicle rear, or at least one lift axle. Moreover, the invention relates to corresponding systems, to a control unit for implementing the method, and to a vehicle with a system.

### BACKGROUND

Vehicles with an anti-lock system, in particular vehicles with an electronic braking system, exhibit wheel-speed sensors. The latter are also designated as ABS sensors. The actual speeds of the wheels in question are measured with the wheel-speed sensors. The signals of the wheel-speed sensors are processed for the purpose of controlling the brakes. One objective is the avoidance of locking wheels.

Vehicles exhibit, in particular on their rear, signal generators and/or signal receivers that are active in the course of reverse travel, for example ultrasonic sensors. The energizing thereof may have been coupled with the engaging of a reverse gear. In this case, the engaged reverse gear has to be detected and read in via an electrical lead.

In the case of a trailer coupled to a motor vehicle, a cable has to lead to the trailer, so that the information about the engaged reverse gear can be transmitted to the trailer.

An object of the present invention is the creation of a method for controlling travel-direction-dependent functions (forward/reverse and, where appropriate, standstill), without the actual state of the transmission having to be detected.

For the purpose of achieving the object, the method according to one aspect of the invention provides that a direction of rotation is also detected with the wheel-speed sensor. The signal generators and/or signal receivers assigned, in particular, to the vehicle rear are actuated automatically in a manner depending on the signals of the wheel-speed sensor. A read-out of the state of the transmission is not required. The evaluation of the signals of the wheel-speed sensor is sufficient. But the signals thereof are received and processed anyway by an electronic braking system. For the purpose of recognizing the direction of rotation, use may be made of special wheel-speed sensors. Already known are so-called active ABS sensors. These require, in contrast to passive ABS sensors, an independent power supply, and provide not only speed-dependent signals but also information about the direction of rotation of the sensed wheels.

The signal generators or signal receivers are advantageously optically or acoustically active. In particular, it is a question of at least one reversing lamp, a reversing camera, a distance sensor and/or other elements of a rear-space monitoring system. The reversing lamp is an optical signal generator, the ultrasonic sensor is an optical signal receiver, and the distance sensor is, for example, an ultrasonic sensor emitting and receiving acoustic signals. One or more of the stated elements are switched on or activated when reverse travel is detected.

According to a further idea of the invention, a braking operation of the vehicle is controlled in a manner depending on signals of the signal receiver. As a result of this, an automatic application of the brakes when reversing is possible, for example, particularly in connection with an electronic braking system.

As an alternative or in addition to the actuation of the signal generators and/or signal receivers, a lift axle which has been provided can also be actuated automatically in a manner depending on signals of the wheel-speed sensor. In this way, the lift axle can be relieved and/or raised when reverse travel is detected by the wheel-speed sensor. Typically, the lift axle is raised hydraulically or pneumatically. The drive is effected via a solenoid valve. The latter may, for example, have been linked to the electronic braking system.

According to a further aspect of the invention, a direction of rotation is also detectable with the wheel-speed sensor. At the same time, means for driving the signal receivers and/or signal generators in a manner depending on signals of the wheel-speed sensor have been provided. A means of such a type may be a control unit, in particular a control unit for an electronic braking system of the vehicle, where appropriate in conjunction with further means such as electrically drivable valves and switches.

The wheel-speed sensor may have been assigned to an electronic braking system and/or may be an active ABS sensor.

In accordance with yet another aspect of the invention, optical and/or acoustic signal receivers or signal generators have been provided, in particular at least one reversing lamp, a reversing camera, a distance sensor and/or other elements of a rear-space monitoring system.

According to a further aspect, in a system according to the invention a direction of rotation may also be detectable with the wheel-speed sensor, in which case, in addition, means for driving the lift axle in a manner depending on signals of the wheel-speed sensor have been provided.

Advantageously, the system has been configured in such a way that the lift axle can be relieved and/or raised when reversing.

A control unit may have been provided as driving means, in particular a control unit of an electronic braking system of the vehicle. The wheel-speed sensor may have been assigned to the electronic braking system. The wheel-speed sensor may also be an active ABS sensor.

A control unit for implementing the method according to the invention is also a subject of the invention.

Finally, a vehicle with a system according to the invention, in particular a trailer, is also a subject of the invention.

Further features of the invention and advantageous embodiments of the invention will be elucidated in the following on the basis of the single FIGURE.

### BRIEF DESCRIPTION OF THE DRAWING

In the drawing,

FIG. 1 shows a trailer with a swiveling tow bar.

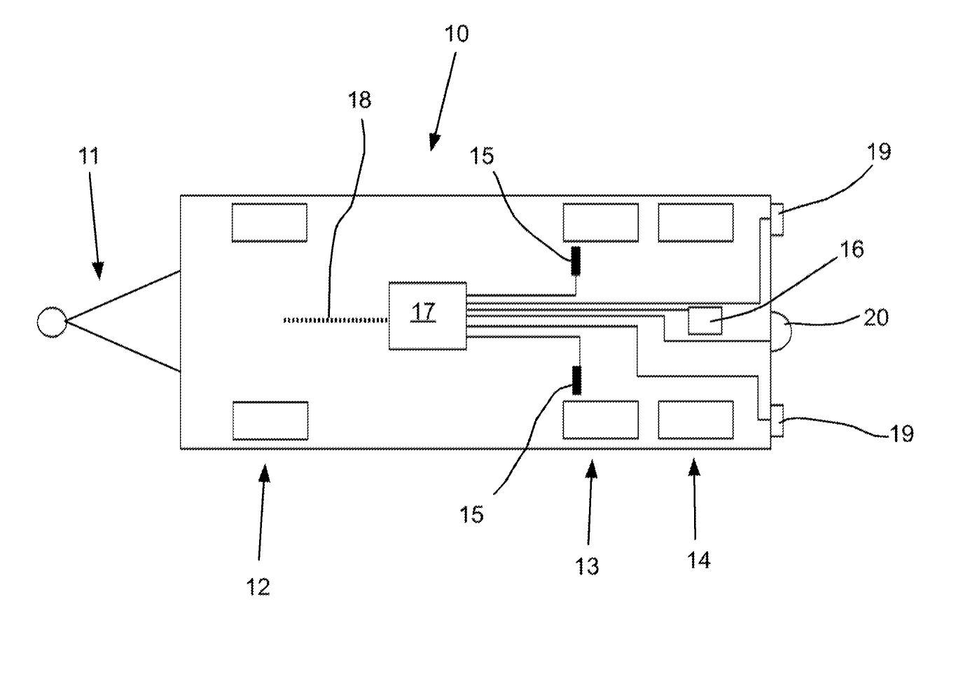

### DETAILED DESCRIPTION OF THE DRAWING

Shown is a trailer 10 with swiveling tow bar 11, with a front axle 12 and with two rear axles 13, 14. The anterior one of the rear axles 13, 14 will be designated in the following, for the purpose of better differentiation, as the central axle 13.

Wheel-speed sensors 15 have been assigned at least to the central axle 13. The rear axle 14 is a lift axle which can be raised pneumatically. For the purpose of driving the lift-axle function, a solenoid valve 16 has been assigned to the rear axle 14.

The trailer 10 is equipped with an electronic braking system with which pneumatic brakes, which are not shown, can be driven. For this purpose a control unit 17 has been provided which typically has been connected, via a standardized interface 18, to an electronic braking system of a motor vehicle which is not shown.

Besides the driving of the brakes, the control unit 17 has further tasks. Also driven are the solenoid valve 16 for the rear axle 14 (lift axle), and reversing lamps 19, as well as an ultrasonic sensor 20. The drive of the components 16, 19, 20 is effected here in a manner depending on the signals of the wheel-speed sensors 15. The latter have been designed to recognize the direction of rotation. In particular, it is a question of active sensors. Regarded as active sensors here are sensors that have to be supplied with a voltage and that emit signals from which the direction of rotation and, preferentially, also a standstill can be recognized.

The components 15, 16, 19, 20 have been linked to the control unit 17. In the control unit 17 a control logic circuit has been wired or programmed—that is to say, realized in hardware or software—so that in the course of reverse travel the reversing lamps 19 radiate automatically and the ultrasonic sensor 20 has been switched on automatically. The ultrasonic sensor 20 scans the environment at the rear of the trailer 10. In the course of approaching an object, a feedback to the control unit 17 takes place, either for the purpose of generating acoustic signals and/or for obligatory actuation of the brakes.

In the system that is represented, in addition there is provision that when reverse travel is recognized the rear axle 14 (lift axle) is raised or at least relieved by drive of the solenoid valve 16. Very often, the reverse travel is associated with steering movements and corresponding cornering maneuvers. The raising of one of the two axles 13, 14 facilitates the maneuvering of the trailer 10 and reduces the tire wear. The raising of the rear axle 14 can be blocked by the signals of an axle-load sensor which is not shown.

A particular advantage of the trailer 10 that is represented consists in the fact that reverse travel is recognized automatically and triggers actions, without the engaging of the reverse gear having to be communicated from the motor vehicle. The trailer 10 uses the signals of the wheel-speed sensors, which typically pertain to the electronic braking system and which have been provided anyway, for the purpose of recognizing reverse travel.

The system that is represented on the basis of the trailer 10 is, of course, also applicable to a motor vehicle. A feedback from the transmission to the control unit concerning the engaged reverse gear is then not required also in the motor vehicle.

While the above description constitutes the preferred embodiments of the present invention, it will be appreciated that the invention is susceptible to modification, variation and change without departing from the proper scope and fair meaning of the accompanying claims.

What is claimed is:

1. A method for controlling functions in a vehicle having a wheel-speed sensor (15) and having at least one of signal generators or signal receivers assigned to a vehicle rear, the method comprising the steps of
detecting a direction of rotation with the wheel-speed sensor (15), and
actuating the at least one of the signal generators or signal receivers automatically in a manner depending on signals of the wheel-speed sensor (15).

2. The method as claimed in claim 1, wherein an active ABS sensor is used as the wheel-speed sensor (15).

3. The method as claimed in claim 1 wherein the at least one of the signal generators or signal receivers operates with optical or acoustical signals.

4. The method as claimed in claim 1 further comprising the step of controlling a braking operation of the vehicle based on signals of the signal receivers.

5. The method as claimed in claim 1, wherein the vehicle has a lift axle forming the signal receiver, wherein the lift axle is actuated automatically in a manner depending on the signals of the wheel-speed sensor (15).

6. The method as claimed in claim 5, wherein the lift axle is relieved or raised when reverse travel is detected by the wheel-speed sensor (15).

7. A system for controlling functions in a vehicle having at least one wheel-speed sensor (15) and having one at least one of signal generators or signal receivers assigned to a vehicle rear, wherein the system is configured to detect a direction of rotation with the wheel-speed sensor (15), and for driving the at least one of the signal receivers or signal generators in a manner depending on signals of the wheel-speed sensor (15).

8. The system as claimed in claim 7, further comprising a control unit (17) that also controls an electronic braking system of the vehicle.

9. The system as claimed in claim 7, wherein the wheel-speed sensor (15) has been assigned to an electronic braking system.

10. The system as claimed in claim 7 wherein the wheel-speed sensor (15) is an active ABS sensor.

11. The system as claimed in claim 7 wherein the at least one of the signal receivers or signal generators operates with optical or acoustical signals.

12. The system of claim 7, wherein the vehicle has a lift axle, the system being configured to detect a direction of rotation with the wheel-speed sensor (15), and for driving the lift axle in a manner depending on the signals of the wheel-speed sensor (15).

13. The system as claimed in claim 12, wherein the system is configured to relive or raise the lift axle when the vehicle is reversing.

14. The system as claimed in claim 12, further comprising a control unit (17) that also controls an electronic braking system of the vehicle.

15. The system as claimed in claim 12 wherein the wheel-speed sensor (15) has been assigned to an electronic braking system.

16. The system as claimed in claim 12 wherein the wheel-speed sensor (15) is an active ABS sensor.

17. (canceled)

18. A vehicle with a system as claimed in claim 6, wherein the vehicle is a trailer (10).

19. The method as claimed in claim 3, wherein the at least one of the signal generators or signal receivers is at least one of a reversing lamp (19), a reversing camera, a distance sensor, or another element of a rear-space monitoring system.

20. The method as claimed in claim 11, wherein the at least one of the signal generators or signal receivers is at least one of a reversing lamp (19), a reversing camera, a distance sensor, or another element of a rear-space monitoring system.
